(19) United States
(12) Patent Application Publication
(10) Pub. No.: US 2026/0031328 A1
(43) Pub. Date: Jan. 29, 2026

(54) POSITIVE ELECTRODES AND RECHARGEABLE LITHIUM BATTERIES INCLUDING THE SAME

(71) Applicant: SAMSUNG SDI CO., LTD., Yongin-si (KR)

(72) Inventors: Yuhyun KIM, Yongin-si (KR); Yong-Kyun PARK, Yongin-si (KR); Da-Un HAN, Yongin-si (KR); Mingu CHOI, Yongin-si (KR); Sanghee NAM, Yongin-si (KR); Eunhyeon HA, Yongin-si (KR); Jingu YEOM, Yongin-si (KR)

(73) Assignee: SAMSUNG SDI CO., LTD., Yongin-si (KR)

(21) Appl. No.: 19/279,911

(22) Filed: Jul. 24, 2025

(30) Foreign Application Priority Data
Jul. 26, 2024 (KR) 10-2024-0099698

(51) Int. Cl. H01M 4/131; H01M 4/36; H01M 4/525; H01M 4/58; H01M 4/62; H01M 10/052

(52) U.S. Cl. CPC H01M 4/131; H01M 4/364; H01M 4/525; H01M 4/58; H01M 4/623; H01M 10/052

(57) ABSTRACT

A positive electrode includes a positive electrode current collector and a positive electrode active material layer on the positive electrode current collector and including a positive electrode active material and a binder. The positive electrode active material includes a first positive electrode active material including a lithium iron phosphate-based compound and a second positive electrode active material including a lithium nickel-based composite oxide. The binder includes a first fluorine-based binder not including a polar functional group, and a second fluorine-based binder including a polar functional group. A weight ratio of the first fluorine-based binder to the second fluorine-based binder is in a range of about 1:1 to about 4:1. The rechargeable lithium battery including the positive electrode may exhibit high initial charge/discharge capacity and efficiency even under high voltage driving conditions, and can exhibit long cycle-life characteristics.

### CROSS-REFERENCE TO RELATED APPLICATION

This application claims priority to Korean Patent Application No. 10-2024-0099698 filed in the Korean Intellectual Property Office on Jul. 26, 2024, the entire contents of which are incorporated herein by reference.

### BACKGROUND

### 1. Field

Positive electrodes, and rechargeable lithium batteries including the positive electrodes, are disclosed.

### 2. Description of the Related Art

A portable information device such as a cell phone, a laptop, smart phone, and the like, or an electric vehicle, typically uses a rechargeable lithium battery having high energy density and portability as a driving power source. A rechargeable lithium battery with high energy density may be advantageous as a driving power source or power storage power source for hybrid or electric vehicles.

Due to increasing demand for large-sized, high-capacity, or high-energy-density rechargeable lithium batteries, developing positive electrode active materials and binders that can increase capacity while ensuring stability and enable operation at high voltages may be advantageous.

### SUMMARY

Some example embodiments include a positive electrode active material and a binder capable of achieving high density, high capacity, long cycle-life characteristics and high energy density, as well as a positive electrode and a rechargeable lithium battery using the positive electrode.

In some example embodiments, a positive electrode includes a positive electrode current collector; and a positive electrode active material layer on the positive electrode current collector and including a positive electrode active material and a binder. The positive electrode active material includes a first positive electrode active material including a lithium iron phosphate-based compound; and a second positive electrode active material including a lithium nickel-based composite oxide. The binder is included in an amount in a range of about 1 wt % to about 4 wt % based on 100 wt % of the positive electrode active material layer. The binder includes a first fluorine-based binder not including a polar functional group; and a second fluorine-based binder including a polar functional group. A weight ratio of the first fluorine-based binder to the second fluorine-based binder is in a range of about 1:1 to about 4:1.

In some example embodiments, a rechargeable lithium battery including the positive electrode, a negative electrode, and an electrolyte is provided.

The positive electrode according to some example embodiments increases or maximizes capacity while reducing or minimizing production cost, thereby ensuring long cycle-life characteristics and improving high-voltage characteristics and high-temperature storage characteristics. The rechargeable lithium battery including the positive electrode may exhibit high initial charge/discharge capacity and efficiency even under high voltage driving conditions, and can achieve long cycle-life characteristics.

### BRIEF DESCRIPTION OF THE DRAWINGS

FIGS. 1 to 4 are views schematically illustrating a lithium rechargeable battery, according to some example embodiments.

### DETAILED DESCRIPTION

Hereinafter, example embodiments are described in detail so that those of ordinary skill in the art can readily implement the example embodiments. However, this disclosure may be embodied in many different forms and is not construed as being limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, it can be “directly on” the other element, or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may indicate the diameter (D₅₀) of particles having a cumulative volume of 50 volume % in the particle size distribution. As used herein, when a definition is not otherwise provided, the average particle diameter indicates a diameter (D₅₀) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Positive Electrode

In some example embodiments, a positive electrode includes a positive electrode current collector; and a positive electrode active material layer located on the positive electrode current collector and including a positive electrode active material and a binder. The positive electrode active material includes a first positive electrode active material including a lithium iron phosphate-based compound; and a second positive electrode active material including a lithium nickel-based composite oxide. The binder is included in an amount in a range of about 1 wt % to about 4 wt % based on 100 wt % of the positive electrode active material layer. The binder includes a first fluorine-based binder not including a polar functional group; and a second fluorine-based binder including a polar functional group. A weight ratio of the first fluorine-based binder to the second fluorine-based binder is in a range of about 1:1 to about 4:1. The positive electrode active material layer may further include another type of positive electrode active material in addition to the aforementioned positive electrode active material. Additionally, the positive electrode active material layer may optionally further include a conductive material.

The positive electrode secures or increases safety by using a mixture of a lithium iron phosphate-based compound and a lithium nickel-based composite oxide as the positive electrode active material, thereby increasing the capacity thereof and enabling operation at high voltage. In addition, by controlling the content and composition of the binder as desired, the composition of the positive electrode active material can be stabilized, and the adhesion to the positive electrode current collector can be improved.

### Positive Electrode Active Material Layer

The positive electrode active material layer according to some example embodiments is located on a positive electrode current collector, and includes a positive electrode active material and a binder. The positive electrode active material includes a first positive electrode active material including a lithium iron phosphate-based compound, and a second positive electrode active material including a lithium nickel-based composite oxide.

According to some example embodiments, the first positive electrode active material includes a lithium iron phosphate-based compound. The lithium iron phosphate-based compound can improve heat resistance and thermal stability, and can also increase capacity or increasing output. For example, the lithium iron phosphate-based compound may be represented by Chemical Formula 1 or Chemical Formula 2.

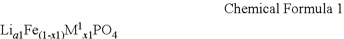

In Chemical Formula 1, 0.90≤a1≤1.5, 0≤x1≤0.4, and M1 is or includes at least one of Al, B, Ca, Ce, Cr, Cu, La, Mg, Mn, Mo, Nb, Ni, Si, Sn, Sr, Ti, V, W, Y, Zn, Zr, or a combination thereof. Herein, 0.90≤a1≤1.5, for example, 0.90≤a1≤1.2, or 0.95≤a1≤1.1. Additionally, 0x1≤0.4, 0≤x1≤0.3, 0≤x1≤0.2, 0≤x1≤0.1, or 0≤x1≤0.05.

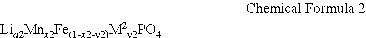

In Chemical Formula 2, 0.90≤a2≤1.5, 0.1≤x2≤0.9, 0≤y2≤0.9, and M2 is or includes at least one of Al, B, Ca, Ce, Cr, Cu, La, Mg, Mo, Nb, Ni, Si, Sn, Sr, Ti, V, W, Y, Zn, Zr, or a combination thereof. Herein, 0.90≤a2≤1.5, or for example, 0.90≤a2≤1.2, or 0.95≤a2≤1.1. Additionally, 0.1≤x2≤0.9, 0.3≤x2≤0.9, or 0.4≤x2≤0.8, and 0≤y2≤0.4, 0≤y2≤0.3, 0≤y2≤0.2, 0≤y2≤0.1, or 0≤y2≤0.05.

For example, the lithium iron phosphate-based compound may include at least one of LifePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, or a combination thereof.

The first positive electrode active material including the lithium iron phosphate-based compound is in the form of particles, and the average particle diameter (D₅₀) of the particles may be in a range of about 0.01 μm to about 2 μm, for example, about 0.1 μm to about 1 μm, or about 0.2 μm to about 0.9 μm. As used herein, when a definition is not otherwise provided, the average particle diameter (D₅₀) indicates a diameter of particles having a cumulative volume of 50 volume % in the particle size distribution that is obtained by measuring the size (diameter or major axis length) of about 20 particles at random in a scanning electron microscope image for positive electrode active materials.

The lithium iron phosphate-based compound may be in the form of first particles, second particles, or a mixture of first particles and second particles.

The first particles may be an assembly of multiple nano-sized primary particles or a secondary particle. The first particles may have a substantially spherical or ellipsoidal shape as the primary particles are closely packed together. The average particle diameter of the first particles may be in a range of, for example, about 2 μm to about 15 μm, about 3 μm to about 12 μm, or about 3 μm to about 10 μm. The average particle diameter of the first particle may be larger than the average particle diameter of the second particle, which is described below. The average particle diameter of the primary particles of the first particle may be in a range of, for example, about 10 nm to about 400 nm, about 20 nm to about 300 nm, or about 50 nm to about 200 nm. For example, the average particle diameter of the first particles may be obtained by randomly selecting about 30 first particles from an electron microscope image of a lithium iron phosphate-based compound, measuring the particle diameter, and taking the diameter (D₅₀) of the particles having a cumulative volume of 50 volume % from the particle size distribution as the average particle diameter. The average particle diameter of the primary particles of the first particle may be obtained by measuring the sizes of about 30 primary particles in an electron microscope image of the surface or cross-section of the first particle, and taking the diameter (D₅₀) of the particles having a cumulative volume of 50 volume % in the particle size distribution as the average particle diameter.

A porosity of the first particle may be in a range of about 20% to about 50%. The porosity may be obtained by measuring an area ratio of the portion occupied by pores within the particle using an image analysis program such as Image J in a scanning electron microscope image of a cross-section of the first particle.

The second particle may have the form of a single particle. An average particle diameter of the second particles may be in a range of, for example, about 10 nm to about 900 nm, about 50 nm to about 500 nm, or about 100 nm to about 300 nm. The average particle diameter of the second particles may be smaller than the average particle diameter of the first particles, and the average particle diameter of the second particles may be equal to or larger than the average particle diameter of the primary particles of the first particles. For example, the average particle diameter of the second particles can be obtained by randomly selecting about 30 second particles from an electron microscope image of a lithium iron phosphate-based compound, measuring the particle sizes, and taking the diameter (D₅₀) of the particles having a cumulative volume of 50 volume % from the particle size distribution as the average particle diameter.

The lithium iron phosphate-based compound may further include a carbon coating layer on the particle surface. The carbon coating layer may improve the electrical conductivity of the lithium iron phosphate-based compound and reduce the resistance of the positive electrode. The carbon coating layer may be formed using at least one raw material that is or includes, for example, at least one of glucose, sucrose, lactose, starch, oligosaccharide, polyoligosaccharide, fructose, cellulose, a polymer of furfuryl alcohol, a block copolymer of ethylene and ethylene oxide, a vinyl resin, a cellulose resin, a phenol resin, a pitch resin, and a tar resin. For example, the carbon coating layer may be formed by arranging the raw materials on the surface of the lithium iron phosphate-based compound particles and then performing a sintering process.

According to some example embodiments, the second positive electrode active material includes a lithium nickel-based composite oxide. By including the lithium nickel-based composite oxide, the characteristics of lithium iron phosphate-based compounds such as heat resistance and thermal stability are maintained, while the capacity is increased and operation at high voltage is enabled. For example, the lithium nickel-based composite oxide may be represented by Chemical Formula 3.

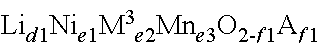

In Chemical Formula 3, 0.9≤a3≤1.8, 0.3≤x3≤1, 0≤y3≤0.7, 0≤z3≤0.7, 0.9≤x3+y3+z3≤1.1, and 0≤b3≤0.1, and M3 and M4 each independently are or include one or more of Al, B, Ba, Ca, Ce, Co, Cr, Cu, Fe, Mg, Mn, Mo, Nb, Si, Sn, Sr, Ti, V, W, Zn, and Zr, and X is or includes one or more of F, P, and S.

In Chemical Formula 3, 0.6≤x3≤1, 0≤y3≤0.4, and 0≤z3≤0.4, or 0.8≤x3≤1, 0≤y3≤0.2, and 0≤z3≤0.2, or 0.9≤x3≤1, 0≤y3≤0.1, and 0≤z3≤0.1.

For example, the second positive electrode active material may be or include a high nickel-based positive electrode active material in which a nickel content is greater than or equal to about 80 mol %, greater than or equal to about 85 mol %, greater than or equal to about 90 mol %, greater than or equal to about 91 mol %, greater than or equal to about 94 mol %, or greater than or equal to 99 mol % based on 100 mol % of a metal excluding lithium in the lithium nickel-based composite oxide. The high nickel-based positive electrode active material may achieve high capacity, and may be applicable to high-capacity, high-density rechargeable lithium batteries.

The second positive electrode active material including the lithium nickel-based composite oxide may be in a form of particles, and the particles may be in a form of secondary particles formed by agglomeration of a plurality of primary particles, single particles, or a combination thereof. The secondary particles and single particles may be substantially spherical, elliptical, polyhedral, or irregular in shape, and primary particles constituting the secondary particles may be substantially spherical, elliptical, plate-shaped, or a combination thereof.

An average particle diameter (D₅₀) of the second positive electrode active material may be in a range of about 10 μm to about 25 μm, for example about 11 μm to about 20 μm, or about 12 μm to about 18 μm. As used herein, when a definition is not otherwise provided, the average particle diameter (D₅₀) indicates a diameter of particles having a cumulative volume of 50 volume % in the particle size distribution that is obtained by measuring the size (diameter or major axis length) of about 20 particles at random in a scanning electron microscope image for positive electrode active materials.

The first positive electrode active material may be included in an amount in a range of about 10 wt % to about 90 wt %, for example, about 60 wt % to about 90 wt %, about 70 wt % to about 90 wt %, or about 80 wt % to about 90 wt %, based on 100 wt % of the first positive electrode active material and the second positive electrode active material, and the second positive electrode active material may be included in an amount in a range of about 10 wt % to about 90 wt %, for example about 10 wt % to about 40 wt %, about 10 wt % to about 30 wt %, or about 10 wt % to about 20 wt % based on 100 wt % of the first positive electrode active material and the second positive electrode active material. When the contents of the first positive electrode active material and the second positive electrode active material are within the above ranges, it is possible to increase the capacity and enable operation at high voltage while ensuring safety.

### Binder

The binder is configured to adhere the positive electrode active material particles to each other and also to adhere the positive electrode active material to the positive electrode current collector.

The binder may be included in an amount in a range of about 1 wt % to 4 wt % based on 100 wt % of the positive electrode active material layer, for example, about 2.5 wt % to about 3.5 wt %, or about 2 wt % to about 3 wt %. When the binder is included within the above ranges, the adhesion of the positive electrode active material particles to each other may not only be increased in the mixed composition of the first and second positive electrode active materials, but may also improve flexibility of the electrode plate.

The binder is configured to include a first fluorine-based binder not including a polar functional group and a second fluorine-based binder including a polar functional group, wherein the first fluorine-based binder and the second fluorine-based binder have a weight ratio in a range of about 1:1 to about 4:1.

Considering the challenges of a general binder such as a fluorine-based binder that does not include a polar functional group, and deteriorates adhesion of an electrode plate, flexibility of the electrode plate, and dispersibility of a conductive material, the fluorine-based binder not including a polar functional group may be mixed with a fluorine-based binder including a polar functional group to simultaneously or contemporaneously increase the adhesion of the electrode plate, the flexibility of the electrode plate, and the dispersibility of the conductive material, thus providing a binder capable of providing a rechargeable lithium battery with improved energy density and cycle-life characteristics.

The first fluorine-based binder may be or include a vinylidene fluoride-based binder that does not include a polar functional group.

The first fluorine-based binder may be or include a homopolymer of a vinylidene fluoride monomer, or a copolymer of a vinylidene fluoride monomer and one or more fluorine-containing monomers such as or including at least one of tetrafluoroethylene, hexafluoropropylene, chlorotrifluoroethylene, fluorovinyl, and perfluoroalkyl vinyl ether. For example, the first fluorine-based binder may be or include at least one of a vinylidene fluoride homopolymer, a vinylidene fluoride-hexafluoropropylene copolymer, a vinylidene fluoride-chlorotrifluoroethylene copolymer, or the like.

The first fluorine-based binder may be included in an amount in a range of about 50 wt % to about 80 wt % based on 100 wt % of the binder, for example, about 55 wt % to about 75 wt % or about 60 wt % to about 70 wt %. When the first fluorine-based binder is included within the above ranges, stability of the positive electrode active material slurry may be improved to enhance flexibility and adhesion of the positive electrode active material layer, and dispersibility of the conductive material may be improved.

The first fluorine-based binder may have a weight average molecular weight that is greater than or equal to about 100,000 g/mol, for example, in a range of about 100,000 to about 1,500,000 g/mol, about 300,000 to about 1,200,000 g/mol, or about 500,000 to about 700,000 g/mol. The weight average molecular weight is a polystyrene conversion value obtained by gel permeation chromatography. When the first fluorine-based binder has a weight average molecular weight within the above ranges, the stability of the positive electrode active material slurry may be improved, further improving dispersibility of the positive electrode active material in the positive electrode active material slurry.

The second fluorine-based binder may be or include a vinylidene fluoride binder including a polar functional group.

The polar functional group of the second fluorine-based binder may be or include at least one of a carboxylic acid group, a sulfonic acid group, a phosphoric acid group, a hydroxyl group, or a combination thereof, but is not limited thereto, and any group that is a polar functional group in the relevant technical field may be included.

A monomer including a carboxylic acid group include monocarboxylic acid and a derivative thereof, dicarboxylic acid and a derivative thereof, and the like. The monocarboxylic acid may include at least one of acrylic acid, methacrylic acid, and crotonic acid. The monocarboxylic acid derivative may include at least one of 2-ethylacrylic acid, isocrotonic acid, α-acetoxyacrylic acid, β-trans-aryloxyacrylic acid, α-chloro-β-E-methoxyacrylic acid, and β-diaminoacrylic acid. The dicarboxylic acid may include at least one of maleic acid, fumaric acid, and itaconic acid. The dicarboxylic acid derivative may include at least one of maleic acid such as methylmaleic acid, dimethylmaleic acid, phenylmaleic acid, chloromaleic acid, dichloromaleic acid, and fluoromaleic acid; a maleate such as methylallyl maleate, diphenyl maleate, nonyl maleate, decyl maleate, dodecyl maleate, octadecyl maleate, and fluoroalkyl maleate. Additionally, an acid anhydride that generates a carboxyl group by hydrolysis can also be included. The acid anhydride of dicarboxylic acid may include at least one of maleic anhydride, acrylic anhydride, methyl maleic anhydride, and dimethyl maleic anhydride. In addition, examples thereof may include monoester and diester of α,β-ethylenically unsaturated polycarboxylic acid, such as or including at least one of monoethyl maleate, diethyl maleate, monobutyl maleate, dibutyl maleate, monoethyl fumarate, diethyl fumarate, monobutyl fumarate, dibutyl fumarate, monocyclohexyl fumarate, dicyclohexyl fumarate, monoethyl itaconate, diethyl itaconate, monobutyl itaconate, and dibutyl itaconate.

The monomer including a sulfonic acid group may include at least one of vinylsulfonic acid, methylvinylsulfonic acid, (meth)allylsulfonic acid, styrenesulfonic acid, ethyl (meth)acrylate-2-sulfonate, 2-acrylamide-2-methylpropanesulfonic acid, and 3-allyloxy-2-hydroxypropanesulfonic acid.

The monomer including a phosphoric acid group (or a phosphate group) may include at least one of 2-(meth)acryloyloxyethyl phosphate, methyl-2-(meth)acryloyloxyethyl phosphate, and ethyl-(meth)acryloyloxyethyl phosphate.

The monomer including a hydroxyl group may be or include ethylenically unsaturated alcohol such as or including at least one of (meth)allyl alcohol, 3-buten-1-ol, and 5-hexene-1-ol; alkanol ester of ethylenically unsaturated carboxylic acid such as or including at least one of 2-hydroxyethyl acrylate, 2-hydroxypropyl acrylate, 2-hydroxyethyl methacrylate, 2-hydroxypropyl methacrylate, di2-hydroxyethyl maleate, di4-hydroxybutyl maleate, and di2-hydroxypropyl itaconate; ester of (meth)acrylic acid and a polyalkylene glycol represented by the general formula CH₂=CR1-COO—(CₙH₂ₙO)ₘ—H (m is an integer from 2 to 9, n is an integer from 2 to 4, and R1 is hydrogen or a methyl group); mono(meth)acrylic acid esters of dihydroxy esters of dicarboxylic acid such as or including at least one of 2-hydroxyethyl-2′-(meth)acryloyloxyphthalate and 2-hydroxyethyl-2′-(meth)acryloyloxysuccinate; vinyl ether such as or including at least one of 2-hydroxyethyl vinyl ether and 2-hydroxypropyl vinyl ether; mono(meth)allyl ether of alkylene glycol such as or including at least one of (meth)allyl-2-hydroxyethyl ether, (meth)allyl-2-hydroxypropyl ether, (meth)allyl-3-hydroxypropyl ether, (meth)allyl-2-hydroxybutyl ether, (meth)allyl-3-hydroxybutyl ether, (meth)allyl-4-hydroxybutyl ether, and (meth)allyl-6-hydroxyhexyl ether; polyoxyalkylene glycol (meth)monoallyl ether such as or including at least one of diethylene glycol mono(meth)allyl ether and dipropylene glycol mono(meth)allyl ether; mono(meth)allyl ethers of halogen and hydroxy substituents of (poly)alkylene glycols such as or including at least one of glycerin mono(meth)allyl ether, (meth)allyl-2-chloro-3-hydroxypropyl ether, and (meth)allyl-2-hydroxy-3-chloropropyl ether; mono(meth)allyl ether of polyhydric phenols such as or including at least one of eugenol and isoeugenol, and halogen substituents thereof; (meth)allyl thioether of alkylene glycol such as or including at least one of (meth)allyl-2-hydroxyethylthioether and (meth)allyl-2-hydroxypropylthioether; and the like.

The second fluorine-based binder may be included in an amount in a range of about 20 wt % to about 50 wt % based on 100 wt % of the biner, for example, about 25 wt % to about 45 wt %, or about 30 wt % to about 40 wt %. When the second fluorine-based binder is included within the above ranges, the adhesion of the positive electrode active material layer to the electrode plate may be improved, and the stability of the positive electrode active material slurry may be enhanced. Accordingly, the first fluorine-based binder and the second fluorine-based binder may be mixed in a weight ratio in a range of about 1:1 to about 4:1, for example, about 1:1 to about 3:1, about 1.5:1 to about 3:1, or about 1.5:1 to about 2.5:1. When the first and second fluorine-based binders have a weight ratio within the above ranges, the adhesion of the positive electrode active material including the first positive electrode active material and the second positive electrode active material may be improved, and flexibility of the electrode plate may also be secured.

The second fluorine-based binder may have a weight average molecular weight that is greater than or equal to about 100,000 g/mol, for example, in a range of about 300,000 g/mol to about 1,500,000 g/mol, about 600,000 g/mol to about 1,300,000 g/mol, or about 900,000 g/mol to about 1,100,000 g/mol. The weight average molecular weight is a polystyrene conversion value obtained by gel permeation chromatography. The adhesion of the second fluorine-based binder to the electrode plate may be further improved when the weight average molecular weight of the second fluorine-based binder is within the above ranges.

The second fluorine-based binder may include at least one of a repeating unit derived from a monomer including a polar functional group; a repeating unit derived from a vinylidene fluoride monomer; and optionally, a repeating unit derived from at least one fluorine-containing monomer such as or including at least one of tetrafluoroethylene, hexafluoropropylene, chlorotrifluoroethylene, fluorovinyl, and perfluoroalkylvinylether.

For example, the second fluorine-based binder, a polar functional group-containing vinylidene fluoride-based binder, may be or include at least one of a copolymer of a monomer including a polar functional group with a vinylidene fluoride monomer or a copolymer of the monomer including a polar functional group, a vinylidene fluoride-based monomer, and the other fluorine-based monomers described above. For example, the polar functional group-containing vinylidene fluoride-based binder may be or include at least one of a polar functional group-containing monomer-vinylidene fluoride copolymer, a polar functional group-containing monomer-vinylidene fluoride-hexafluoropropylene copolymer, a polar functional group-containing monomer-vinylidene fluoride-chlorotrifluoroethylene copolymer, and the like. In the copolymer, a content of the repeating unit derived from fluorine-based monomers other than the vinylidene fluoride monomer may be less than or equal to about 5 mol %.

The positive electrode active material layer may further include other types of binders in addition to the aforementioned first and second fluorine-based binders. Representative examples of the added binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto

### Conductive Material

The positive electrode active material layer may further include a conductive material. The conductive material is included to provide electrode conductivity, and any electrically conductive material may be included as a conductive material unless the electrically conductive material causes a chemical change in the battery. Examples of the conductive material may include a carbon-based material such as at least one of natural graphite, artificial graphite, carbon black, acetylene black, ketjen black, a carbon fiber, a carbon nanofiber, a carbon nanotube, and particulate nanocarbon; a metal-based material including at least one of copper, nickel, aluminum, silver, and the like in the form of metal powder or metal fiber; a conductive polymer such as a polyphenylene derivative; or a combination thereof.

The conductive material may be included in an amount in a range of about 1 wt % to about 4 wt %, for example about 2.5 wt % to about 3.5 wt %, or about 2 wt % to about 3 wt % based on 100 wt % of the positive electrode active material layer. When the content of the conductive material is within the above range, the resistance of the positive electrode including the first positive electrode active material and the second positive electrode active material may be lowered, thereby increasing the capacity of the battery and enabling operation at high voltage.

The positive electrode current collector may include Al, and the like, but is not limited thereto.

### Rechargeable Lithium Battery

Some example embodiments provide a rechargeable lithium battery including the aforementioned positive electrode, negative electrode, and electrolyte. As an example, the rechargeable lithium battery may include a positive electrode, a negative electrode, a separator between the positive electrode and the negative electrode, and an electrolyte solution.

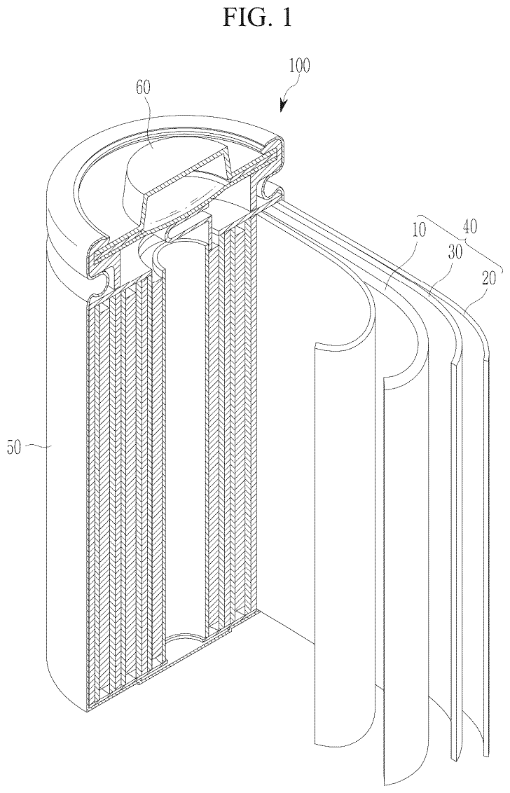

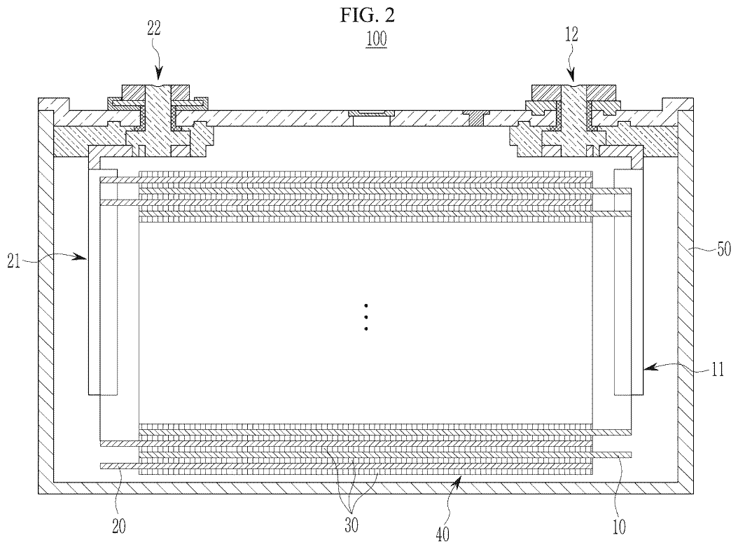

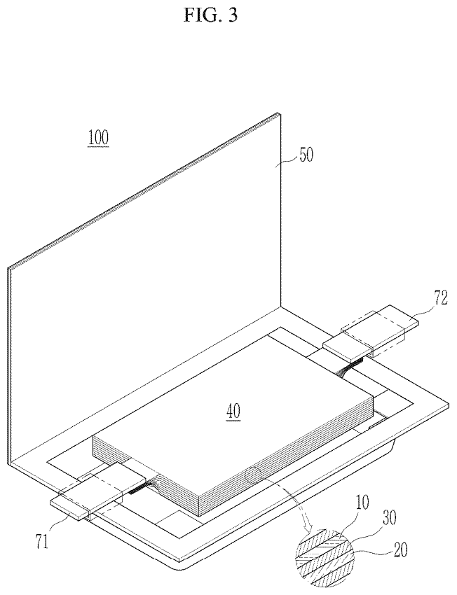

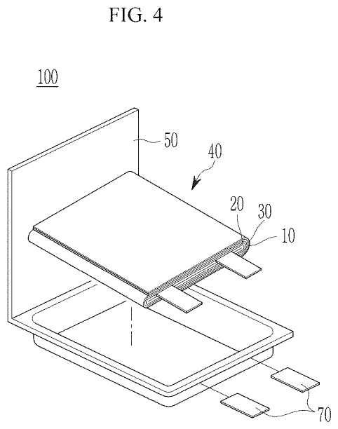

The rechargeable lithium battery may be classified into cylindrical, prismatic, pouch, coin, and the like, depending on the shape. FIGS. 1 to 4 are schematic views illustrating the rechargeable lithium battery according to some example embodiments, where FIG. 1 is a cylindrical battery, FIG. 2 is a prismatic battery, and FIGS. 3 and 4 are a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative electrode lead tab 21, and a negative electrode terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

The rechargeable lithium battery according to some example embodiments may be rechargeable at a high voltage, or suitable for being driven at the high voltage, and exhibit improved characteristics thereof under the high voltage condition.

The rechargeable lithium battery according to some example embodiments may be designed to be operated in a high voltage range, and thus charging may be performed in a voltage range that is greater than or equal to about 4.0 V. The rechargeable lithium battery may implement high capacity and long cycle-life characteristics even when charged at high voltage by applying a positive electrode active material and a conductive material according to some example embodiments.

### Negative Electrode

The negative electrode may include a current collector and a negative electrode active material layer on the current collector, and the negative electrode active material layer may include a negative electrode active material, and may further include at least one of a binder, a conductive material, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOₓ (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof, for example at least one of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof), or a combination thereof. The Sn-based negative electrode active material may be or include at least one of Sn, SnO₂, a Sn alloy, or a combination thereof.

The silicon-carbon composite may be or include a composite of silicon and amorphous carbon. An average particle diameter (D₅₀) of the silicon-carbon composite particles may be in a range of, for example, about 0.5 μm to about 20 μm. According to some example embodiments, the silicon-carbon composite may be in the form of silicon particles, and amorphous carbon coated on the surface of the silicon particles. For example, the silicon-carbon composite may include a secondary particle (core) in which silicon primary particles are assembled, and an amorphous carbon coating layer (shell) on the surface of the secondary particle. The amorphous carbon may also be present between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include at least one of soft carbon or hard carbon, a mesophase pitch carbonized product, and calcined coke.

When the silicon-carbon composite includes silicon and amorphous carbon, a content of silicon may be in a range of about 10 wt % to about 50 wt %, and a content of amorphous carbon may be in a range of about 50 wt % to about 90 wt %, based on 100 wt % of the silicon-carbon composite. For example, when the composite includes silicon, amorphous carbon, and crystalline carbon, a content of silicon may be in a range of about 10 wt % to about 50 wt %, a content of crystalline carbon may be in a range of about 10 wt % to about 70 wt %, and a content of amorphous carbon may be in a range of about 20 wt % to about 40 wt %, based on 100 wt % of the silicon-carbon composite.

For example, a thickness of the amorphous carbon coating layer may be in a range of about 5 nm to about 100 nm. An average particle diameter (D₅₀) of the silicon particles (primary particles) may be in a range of about 10 nm to about 1 μm, or about 10 nm to about 200 nm. The silicon particles may be in the form of silicon alone, in the form of a silicon alloy, or in an oxidized form. The oxidized form of silicon may be represented by SiOₓ (0<x≤2). At this time, the atomic content ratio of Si:O, which indicates a degree of oxidation, may be in a range of about 99:1 to about 33:67. As included herein, when a definition is not otherwise provided, an average particle diameter (D₅₀) indicates a particle where an accumulated volume is about 50 volume % in a particle size distribution.

The Si-based negative electrode active material or Sn-based negative electrode active material may be mixed with the carbon-based negative electrode active material. When the Si-based negative electrode active material or Sn-based negative electrode active material and the carbon-based negative electrode active material are mixed, the mixing ratio thereof may be a weight ratio in a range of about 1:99 to about 90:10.

### Binder

The binder is configured to adhere the negative electrode active material particles to each other, and to adhere the negative electrode active material to the current collector. The binder may be or include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

### Conductive Material

The conductive material is included to provide electrode conductivity, and any electrically conductive material may be included as a conductive material unless the electrically conductive material causes a chemical change in the battery. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

A content of the negative electrode active material may be in a range of about 95 wt % to about 99.5 wt % based on 100 wt % of the negative electrode active material layer, and a content of the binder may be in a range of about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, at least one of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, in a range of about 1 μm to about 20 μm, about 5 μm to about 15 μm, or about 7 μm to about 10 μm.

### Electrolyte

For example, the electrolyte for a rechargeable lithium battery may be an electrolyte solution, which may include a non-aqueous organic solvent and a lithium salt.

The non-aqueous organic solvent may be configured as a medium for transmitting ions taking part in the electrochemical reaction of a battery. The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like and the aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvent can be included alone or in a mixture of two or more types of solvents, and when two or more types of solvents are included in a mixture, a mixing ratio can be adjusted according to the desired battery performance, which is known to those working in the field.

When using a carbonate-based solvent, a cyclic carbonate and a chain carbonate may be mixed, and the cyclic carbonate and the chain carbonate may be mixed in a volume ratio in a range of about 1:1 to about 1:9.

The non-aqueous organic solvent may further include an aromatic hydrocarbon-based organic solvent. For example, a carbonate-based solvent and an aromatic hydrocarbon-based organic solvent may be mixed in a volume ratio in a range of about 1:1 to about 30:1.

The electrolyte solution may further include at least one of vinylethyl carbonate, vinylene carbonate, or an ethylene carbonate-based compound to improve battery cycle-life.

Examples of the ethylene carbonate-based compound may include at least one of fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LICl, LiI, LiN(SO₃C₂F₅)₂, Li(FSO₂)₂N (lithium bis(fluorosulfonyl)imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

A concentration of lithium salt may be within the range of about 0.1 M to about 2.0 M. When the concentration of lithium salt is within the above range, the electrolyte solution has a desired ionic conductivity and viscosity, and thus desired or improved performance can be achieved and lithium ions can move effectively.

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof, on one surface or on both surfaces of the porous substrate.

The porous substrate may be or include a polymer film formed of or include any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyether ether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness in a range of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto. An average particle diameter (D₅₀) of the inorganic particles may be in a range of about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked together.

The thickness of the coating layer may be in a range of about 0.5 μm to about 20 μm, for example, about 1 μm to about 10 μm, or about 1 μm to about 5 μm.

Examples and comparative examples of the present disclosure are described below. However, the following examples are only examples of the present disclosure, and the present disclosure is not limited to the following examples.

### Example 1

### 1. Preparation of Positive Electrode Active Material

### (1) Preparation of First Positive Electrode Active Material

95 wt % of LifePO₄ as a lithium iron phosphate-based compound, 3 wt % of polyvinylidene fluoride as a binder, and 2 wt % of ketjen black as a conductive material were mixed in an N-methylpyrrolidone solvent, preparing a positive electrode active material slurry.

### (2) Preparation of Second Positive Electrode Active Material

Ni_{0.75}Co_{0.24}Al_{0.01}(OH)₂ and LiOH were mixed in a mole ratio of 1:1.05 and primarily heat-treated at 845° C. for 8 hours under an oxygen atmosphere to prepare a lithium nickel-cobalt-aluminum-based composite oxide having a composition of Li_{1.05}Ni_{0.75}Co_{0.24}Al_{0.01}O₂ in the form of secondary particles having an average particle diameter (D₅₀) of about 14 μm.

### (3) Preparation of Final Positive Electrode Active Material

85 wt % of the first positive electrode active material and 15 wt % of the second positive electrode active material were mixed to prepare a positive electrode active material.

### 2. Manufacturing of Rechargeable Lithium Battery Cell

94.5 wt % of the finally prepared positive electrode active material, 3.0 wt % of a binder, and 2.5 wt % of a carbon nanotube conductive material were mixed to prepare a positive electrode active material layer slurry, and the positive electrode active material layer slurry was coated on an aluminum foil current collector and then, dried and compressed to manufacture a positive electrode. Herein, the binder was a mixture of polyvinylidene fluoride (PVdF) as a first fluorine-based binder and a copolymer of a vinylidene fluoride monomer and an acrylic acid monomer as a second fluorine-based binder in a weight ratio of 1:1.

97.5 wt % of a graphite negative electrode active material, 1.5 wt % of carboxymethyl cellulose, and 1 wt % of a styrene butadiene rubber were mixed in a water solvent to prepare a negative electrode active material layer slurry. The negative electrode active material layer slurry was coated on a copper foil current collector and then, dried and compressed to manufacture a negative electrode.

A polytetrafluoroethylene separator was used, and an electrolyte solution prepared by dissolving 1 M LiPF₆ in a mixed solvent of ethylene carbonate and dimethyl carbonate in a volume ratio of 3:7 was used to manufacture a rechargeable lithium battery cell in a common method.

### Examples 2 to 8

A positive electrode and a rechargeable lithium battery cell were manufactured substantially in the same manner as in Example 1 with a difference that the weight ratio of the first and second fluorine-based binders and the content of positive electrode active material based on 100 wt % of the total positive electrode active material layer were changed as shown in Table 1 in the manufacture of the positive electrode.

### Comparative Examples 1 to 13

A positive electrode and a rechargeable lithium battery cell were manufactured substantially in the same manner as in Example 1 with a difference that the weight ratio of the first and second fluorine-based binders and the content of positive electrode active material based on 100 wt % of the total positive electrode active material layer were changed as shown in Table 1 below in the manufacture of the positive electrode.

TABLE 1

| | Weight ratio of | Amount of | |
|---|---|---|---|
| | first fluorine- | positive | |
| | based binder and | electrode | Amount of |
| | second fluorine- | active material | binder |
| | based binder | (wt %) | (wt %) |
| Example 1 | 1:1 | 94.5 | 3.0 |
| Example 2 | 1.5:1 | 94.5 | 3.0 |
| Example 3 | 2:1 | 96.5 | 1.0 |
| Example 4 | 2:1 | 95.5 | 2.0 |
| Example 5 | 2:1 | 94.5 | 3.0 |
| Example 6 | 2:1 | 93.5 | 4.0 |
| Example 7 | 3:1 | 94.5 | 3.0 |
| Example 8 | 4:1 | 94.5 | 3.0 |
| Comparative Example 1 | 1:1 | 97.0 | 0.5 |
| Comparative Example 2 | 1:1 | 93.0 | 4.5 |
| Comparative Example 3 | 1.5:1 | 97.0 | 0.5 |
| Comparative Example 4 | 1.5:1 | 93.0 | 4.5 |
| Comparative Example 5 | 2:1 | 97.0 | 0.5 |
| Comparative Example 6 | 2:1 | 93.0 | 4.5 |
| Comparative Example 7 | 3:1 | 97.0 | 0.5 |
| Comparative Example 8 | 3:1 | 93.0 | 4.5 |
| Comparative Example 9 | 4:1 | 97.0 | 0.5 |
| Comparative Example 10 | 4:1 | 93.0 | 4.5 |
| Comparative Example 11 | 5:1 | 97.0 | 0.5 |
| Comparative Example 12 | 5:1 | 93.0 | 4.5 |
| Comparative Example 13 | 5:1 | 94.5 | 3.0 |

### Evaluation Example 1: Adhesive Strength Evaluation

The positive electrodes according to Examples 1 to 8 and Comparative Examples 1 to 13 were respectively cut to have a width of 25 mm and a length of 100 mm. A double-sided adhesive tape having a width of 20 mm and a length of 40 mm was adhered to an acryl plate having a width of 40 mm and a length of 100 mm. Each of the prepared positive electrodes was attached to the double-sided adhesive tape, and then five times slightly pressed with a hand roller and mounted on a Universal Testing Machine (UTM) (20 kgf load cell), and after peeling off about 25 mm of one side of the positive electrode and fixing the peeled end of the positive electrode to an upper clip of the tensile strength tester, while fixing the tape adhered to one surface of the positive electrode to a lower clip, to peel it at a speed of 100 mm/min and measure 180° peeling strength. Herein, the 180° peeling strength was expressed as adhesion by marking ⊚ when the adhesion was greater than 3 gf/mm, ◯ when the adhesion was 2 gf/mm to 3 gf/mm, Δ when the adhesion was 1 gf/mm to 2 gf/mm, and X when the adhesion was less than 1 gf/mm in Table 2.

### Evaluation Example 2: Flexibility Evaluation

The positive electrodes according to Examples 1 to 8 and Comparative Examples 1 to 13 were measured with respect to flexibility by using a bending strength tester. Each of the positive electrodes was cut into a predetermined size (20 mm*15 mm), mounted on the measuring device, and compressed at a speed of 5 mm/min in a 90° compression direction to measure a maximum point load. When the maximum point load is less than 30 N, ⊚ was given; when the maximum point load is 30 N to 40 N, ◯ was given; when the maximum point load is 40 N to 50 N, Δ was given; and when broken and immeasurable, X was given in Table 2 below.

### Evaluation Example 3: DC-IR Evaluation

The rechargeable lithium battery cells according to Examples 1 to 8 and Comparative Examples 1 to 13 were charged from 2.8 V to an upper limit voltage of 4.15 V (vs. Li/Li⁺) at a constant current of 0.33 C, paused for 30 minutes, and discharged to SOC 50 under the condition of 0.33 C and discharged at 1 C for 10 seconds at 25° C. Herein, the battery cells were measured with respect to initial DC-IR (direct current internal resistance), wherein when DC-IR was less than 15Ω, ∘ was given; when DC-IR was 15Ω to 20Ω, O was given; when DC-IR was 20Ω to 30Ω, Δ was given; and when DC-IR was greater than 30Ω, X was given in Table 2 below.

TABLE 2

| | Adhesion | Flexibility | DC-IR |
|---|---|---|---|
| Example 1 | Δ | ◯ | ◯ |
| Example 2 | ◯ | ◯ | ◯ |
| Example 3 | ◯ | ◯ | ◯ |
| Example 4 | ◯ | ⊚ | ⊚ |
| Example 5 | ⊚ | ⊚ | ⊚ |
| Example 6 | ⊚ | ⊚ | ◯ |
| Example 7 | ⊚ | ◯ | ◯ |
| Example 8 | ⊚ | Δ | ◯ |
| Comparative Example 1 | X | X | X |
| Comparative Example 2 | ⊚ | Δ | Δ |
| Comparative Example 3 | X | X | X |
| Comparative Example 4 | ⊚ | Δ | Δ |
| Comparative Example 5 | X | X | X |
| Comparative Example 6 | ⊚ | Δ | Δ |
| Comparative Example 7 | X | X | X |
| Comparative Example 8 | ⊚ | Δ | Δ |
| Comparative Example 9 | X | X | X |
| Comparative Example 10 | ⊚ | Δ | Δ |
| Comparative Example 11 | X | X | X |
| Comparative Example 12 | ⊚ | X | X |
| Comparative Example 13 | ⊚ | X | X |

Referring to Table 2, the comparative examples in which the binder content was 0.5 wt % or 4.5 wt % based on 100 wt % of the total positive electrode active material layer, compared to the examples, exhibited deteriorated flexibility and increased DC-IR. In particular, when the binder content was 0.5 wt % based on 100 wt % of the total positive electrode active material layer, even the adhesion was deteriorated.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a positive electrode current collector; and
a positive electrode active material layer located on the positive electrode current collector and including a positive electrode active material and a binder;
wherein the positive electrode active material comprises a first positive electrode active material including a lithium iron phosphate-based compound, and a second positive electrode active material including a lithium nickel-based composite oxide;
the binder is included in an amount in a range of about 1 wt % to about 4 wt % based on 100 wt % of the positive electrode active material layer,
the binder comprises a first fluorine-based binder not including a polar functional group, and a second fluorine-based binder including a polar functional group; and
a weight ratio of the first fluorine-based binder to the second fluorine-based binder is in a range of about 1:1 to about 4:1.

2. The positive electrode as claimed in claim 1, wherein the lithium iron phosphate-based compound is represented by Chemical Formula 1 or Chemical Formula 2: 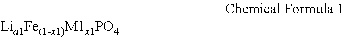
wherein, in Chemical Formula 1, 0.90≤a1≤1.5, 0≤x1≤0.4, and M1 comprises at least one of Al, B, Ca, Ce, Cr, Cu, La, Mg, Mn, Mo, Nb, Ni, Si, Sn, Sr, Ti, V, W, Y, Zn, and Zr: 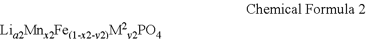
wherein, in Chemical Formula 2, 0.90≤a2≤1.5, 0.1≤x2≤0.9, 0≤y2≤0.9, and M2 comprises at least one of Al, B, Ca, Ce, Cr, Cu, La, Mg, Mo, Nb, Ni, Si, Sn, Sr, Ti, V, W, Y, Zn, and Zr.

3. The positive electrode as claimed in claim 1, wherein the lithium iron phosphate-based compound comprises at least one of LifePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, and LiMn_{0.3}Fe_{0.7}PO₄.

4. The positive electrode as claimed in claim 1, wherein the lithium nickel-based composite oxide has a nickel content that is greater than or equal to about 80 mol % based on 100 mol % of a total metal excluding lithium.

5. The positive electrode as claimed in claim 1, wherein the lithium nickel-based composite oxide is represented by Chemical Formula 3: 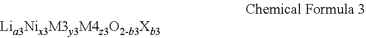
wherein, in Chemical Formula 3, 0.9≤a3≤1.8, 0.3≤x3≤1, 0≤y3≤0.7, 0≤z3≤0.7, 0.9≤x3+y3+z3≤1.1, and 0≤b3≤0.1, M3 and M4 each independently comprises one or more of Al, B, Ba, Ca, Ce, Co, Cr, Cu, Fe, Mg, Mn, Mo, Nb, Si, Sn, Sr, Ti, V, W, Zn, and Zr, and X comprises one or more of F, P, and S.

6. The positive electrode as claimed in claim 1, wherein the first positive electrode active material is included in an amount in a range of about 10 wt % to about 90 wt %, and the second positive electrode active material is included in an amount in a range of about 10 wt % to about 90 wt %, based on 100 wt % of the first positive electrode active material and the second positive electrode active material.

7. The positive electrode as claimed in claim 1, wherein the first positive electrode active material is included in an amount in a range of about 60 wt % to 90 wt %, and the second positive electrode active material is included in an amount in a range of about 10 wt % to about 40 wt %, based on 100 wt % of the first positive electrode active material and the second positive electrode active material.

8. The positive electrode as claimed in claim 1, wherein the first positive electrode active material is included in an amount in a range of about 80 wt % to 90 wt %, and the second positive electrode active material is included in an amount in a range of about 10 wt % to about 20 wt %, based on 100 wt % of the first positive electrode active material and the second positive electrode active material.

9. The positive electrode as claimed in claim 1, wherein the binder is included in an amount in a range of about 2 wt % to about 3 wt % based on 100 wt % of the positive electrode active material layer.

10. The positive electrode as claimed in claim 1, wherein the first fluorine-based binder comprises a homopolymer of vinylidene fluoride monomer.

11. The positive electrode as claimed in claim 1, wherein the polar functional group comprises at least one of a carboxylic acid group, a sulfonic acid group, a phosphoric acid group, and a hydroxyl group.

12. The positive electrode as claimed in claim 1, wherein the second fluorine-based binder comprises a copolymer of a monomer including a polar functional group and a vinylidene fluoride monomer.

13. The positive electrode as claimed in claim 1, wherein a weight ratio of the first fluorine-based binder to the second fluorine-based binder is in a range of about 1.5:1 to about 2.5:1.

14. The positive electrode as claimed in claim 1, wherein the positive electrode active material layer further comprises a conductive material.

15. The positive electrode as claimed in claim 14, wherein the conductive material is included in an amount in a range of about 2 wt % to about 3 wt % based on 100 wt % of the positive electrode active material layer.

16. A rechargeable lithium battery, comprising:
the positive electrode as claimed in claim 1,
a negative electrode, and
an electrolyte.

17. The rechargeable lithium battery as claimed in claim 16, wherein the negative electrode comprises at least one of a carbon-based negative electrode active material, a lithium metal, a lithium metal alloy, and a silicon-based negative electrode active material.
